(19) United States
(12) Patent Application Publication
(10) Pub. No.: US 2018/0225340 A1
(43) Pub. Date: Aug. 9, 2018

(54) CONTROLLING E-MAIL MESSAGE ORGANIZATION IN AN E-MAIL SYSTEM WHEN RECEIVED BY BCC

(71) Applicant: Microsoft Technology Licensing, LLC, Redmond, WA (US)

(72) Inventors: Nathan F. Waddoups, Redmond, WA (US); Robert H. Deupree, JR., Bellevue, WA (US)

(21) Appl. No.: 15/425,008

(22) Filed: Feb. 6, 2017

(51) Int. Cl. G06F 17/30; H04L 12/58

(52) U.S. Cl. CPC G06F 17/30554; H04L 67/42; G06F 17/30477; H04L 51/22

(57) ABSTRACT

When a new message is received in a recipient's mailbox, it is examined to determine whether it was sent via the blind carbon copy (Bcc) field. If so, the recipient's mailbox is examined to determine whether the received message is in reply to another message in the user's mailbox. If so, the message is organizationally relocated (moved to a folder or tagged) based upon the prior message that the received message is in reply to.

### BACKGROUND

Computing systems are currently in wide use. Some computing systems include electronic mail (e-mail) systems that allow users to perform e-mail functionality.

E-mail functionality can include such things as authoring, sending and receiving e-mail messages and attachments, configuring folders and filters, and setting rules for automated organization of e-mail messages, among a wide variety of other things. Many users also use e-mail systems in order to communicate with a group of users, such as users identified on a distribution list, a user group, a collaboration group, among a wide variety of other groups.

Many users also use rules to sort incoming messages into different folders (or to apply different organizational tags to the messages) based on what address the message was sent to. For instance, if a received message was sent to a distribution list, or mailing list or a particular group of users, then the recipient may have a rule in his or her e-mail system that sorts that received message into a particular folder corresponding to the distribution list, mailing list, or group that it was sent to. When a user configures this type of rule in his or her e-mail system, this can greatly assist the user in that the e-mail messages are automatically sorted, upon receipt, so the user need not sort the messages himself or herself. Then, when a user wishes to review messages related to a topic, distribution list, mailing list, or group, the user simply navigates to the appropriate folder, filters by the appropriate tag, or uses another organizational mechanism, corresponding to that group to review any new messages that have been received.

The discussion above is merely provided for general background information and is not intended to be used as an aid in determining the scope of the claimed subject matter.

### SUMMARY

When a new message is received in a recipient's mailbox, it is examined to determine whether it was sent via the blind carbon copy (Bcc) field. If so, the recipient's mailbox is examined to determine whether the received message is in reply to another message in the user's mailbox. If so, the message is organizationally modified (moved to a folder or tagged) based upon the prior message that the received message is in reply to.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of an electronic mail (e-mail) computing system architecture.

FIG. 2 is a flow diagram illustrating one example of the operation of the architecture shown in FIG. 1 in handling an e-mail message received via the Bcc field.

FIG. 3 is a block diagram showing the architecture illustrated in FIG. 1, deployed in a cloud computing architecture.

FIGS. 4-6 show examples of mobile devices that can be used in the architectures shown in the previous figures.

FIG. 7 is a block diagram of one example of a computing environment that can be used in the architectures shown in the previous figures.

### DETAILED DESCRIPTION

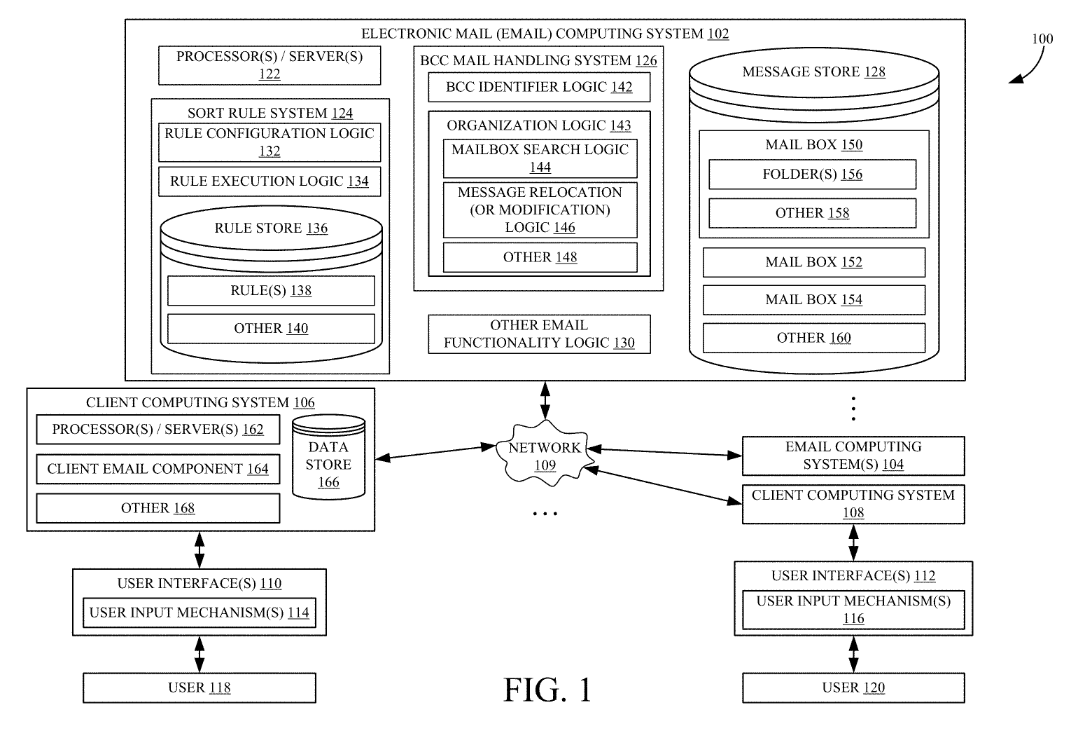

FIG. 1 is a block diagram of one example of an electronic mail (e-mail) computing system architecture 100. Architecture 100 illustratively includes e-mail computing system 102 and it can include other e-mail computing systems 104 as well. In the example shown in FIG. 1, architecture 100 also includes client computing systems 106-108 that are shown generating user interfaces 110-112, with user input mechanisms 114-116 for interaction by users 118-120, respectively. In the example illustrated, systems 102, 104 and 106-108 are illustratively connected for communication with one another over network 109. Network 109 can be any of a wide variety of different types of networks, such as a wide area network, a local area network, a near field communication network, etc. It can include such things as a cellular network, a satellite network, and a wide variety of other items. Thus, users 118-120 can illustratively interact with user input mechanisms 114-116 in order to control and manipulate client computing systems 106 and 108, respectively, and ultimately to control and manipulate one or more of e-mail computing systems 102-104.

E-mail computing systems 102-104 can be similar or different. For purposes of the present discussion, it is assumed that they are similar, so that only e-mail computing system 102 is described in more detail. It is contemplated, however, that different email systems can be used as well. System 102 illustratively includes processor(s) or server(s) 122, sort rule system 124, Bcc mail handling system 126, message store 128, and it can include a wide variety of other e-mail functionality 130.

Sort rule system 124 illustratively includes rule configuration logic 132, rule execution logic 134, and rule store 136 (which, itself, can include rules 138 and other items 140). Bcc mail handling system 126 illustratively includes Bcc identifier logic 142, and organization logic 143 (which itself, can include mailbox search logic 144, message relocation (or modification) logic 146, and it can include other items 148). Message store 128 can include one or more mailboxes 150, 152, and 154, for various users. Each mailbox can include folders 156 (or other organizational characteristics, or structures such as tags) and it can include other items 158. Message store 128 can include other items 160 as well.

Client systems 106-108 can be similar or different. For the sake of the present discussion, it will be assumed that they are similar so that only client computing system 106 is described in more detail. However, it is contemplated that different client systems can be used as well. Client computing system 106 illustratively includes one or more processors or servers 162, client e-mail component 164, data store 166, and it can include a wide variety of other items 168. Client e-mail component 164 can be a client component of e-mail computing systems 102 (or e-mail computing system 104). In another example, the client e-mail component 164 is not needed, and the user 118 can access e-mail computing system 102 directly. All of these and other architectures are contemplated herein.

Before describing the overall operation of architecture 100 in more detail, a brief overview of some of the items in architecture 100, and their operation, will first be provided. Sort rule system 124 illustratively provides functionality that allows users to generate sort rules that can be used to automatically sort incoming e-mail messages. Rule configuration logic 132 illustratively exposes functionality that allows users to write or select different rules to sort e-mail messages. For instance, in one example, user 118 can configure a rule to sort the messages based upon the recipients identified in the “To” field of the e-mail message. This allows the user to have messages for different mailing lists or distribution lists or groups automatically organized in message store 120. For instance, in one example, the messages can be relocated to different folders based upon the rules. In another example, in an e-mail system that uses tags or other properties to organize e-mail messages, the received e-mail messages can be relocated (e.g., tagged with a different organizational tag) based on the rules. Thus, in one example, the term relocation is used herein to mean that the message is organized differently. This can include moving a message to a different folder or changing the organizational tag on a message, or otherwise modifying the message or changing its location within the e-mail system message store, or otherwise, so that it is organized in a particular way.

Once the user has configured a rule using rule configuration logic 132, the rule can be stored as a stored rule 138 in rule store 136. It will be noted that the rules can be stored in other locations as well.

Once the rules are stored, incoming or received e-mail messages can be processed based on those rules. Rule execution logic 134 detects that a message is received and accesses rules 138 to determine whether any of the rules apply to the newly received message. If so, rule execution logic 134 executes the identified rule to reorganize (i.e., relocate) or otherwise process the newly received message.

In using an e-mail system, it is common for e-mail discussions (represented by messages to a mailing list) to be taken off of the mailing list. For example, it may be that a user in a group (represented by a mailing list) may send a message to the group (e.g., to the mailing list) about a particular topic that need not be addressed by the entire group, but may need only to be addressed by one or more people in the group. In that case, one of the recipients may reply-all to the message, move the mailing list address from the “To” field (or the “Cc” field) to the Bcc address field (or address box). The user may then send the message with an explanatory note such as “I'll work on this with John and Jane.”

However, when this happens, everyone in the mailing list receives the message in their inbox, even though they have configured a rule which states that messages to this particular mailing list should be moved to a different folder corresponding to that mailing list (or group). This is because the mailing list's address does not appear in the “To” or “Cc” address boxes, because it was moved to the “Bcc” address box, and the addresses in the Bcc address box are not transmitted to the recipients.

This can be problematic particularly for users who are member of a large numbers of groups. Those members often create rules so that messages directed to the groups are automatically organized into a folder (or tagged with a tag) corresponding to that group. Thus, when they receive the message via Bcc, in their inbox (instead of in the folder corresponding to the group), this can result in unwanted messages arriving in the user's inbox. It can clutter the user's inbox and distracts the user from higher priority messages, due to the volume of messages in the inbox.

In some current systems, rules can be created to handle messages received via Bcc, just based on the fact that they were sent via Bcc. However, the contents of the Bcc address box are only available to the sender; they are not transmitted to recipients. Therefore, rules cannot be used to place the Bcc′d message into the correct folder, because nothing on the message identifies the mailing list that the message was sent to (which is the point of the Bcc address box).

Thus, Bcc handling system 126 handles these types of scenarios. Bcc identifier logic 142 identifies that a received message was received via the Bcc address box. It can generate a signal indicative of that or it can generate some other such indication. Organization logic 143 then determines whether the message is to be organized in a particular way. Mailbox search logic 144 searches the recipient's mailbox (e.g., all the folders in the mailbox or all messages with organizational tags) to identify whether the received message is in reply to another message that is already in the recipient's mailbox. If so, message relocation (or notification) logic 146 relocates (or modifies) the received message by, for example, moving it to the same folder as the prior message that it was in reply to, or tagging it with a corresponding organizational tag.

Other e-mail functionality logic 130 illustratively allows the users to perform a wide variety of other e-mail functionality. This can include authoring and sending messages, attaching and opening attachments, configuring filters, or folders, among a wide variety of other things.

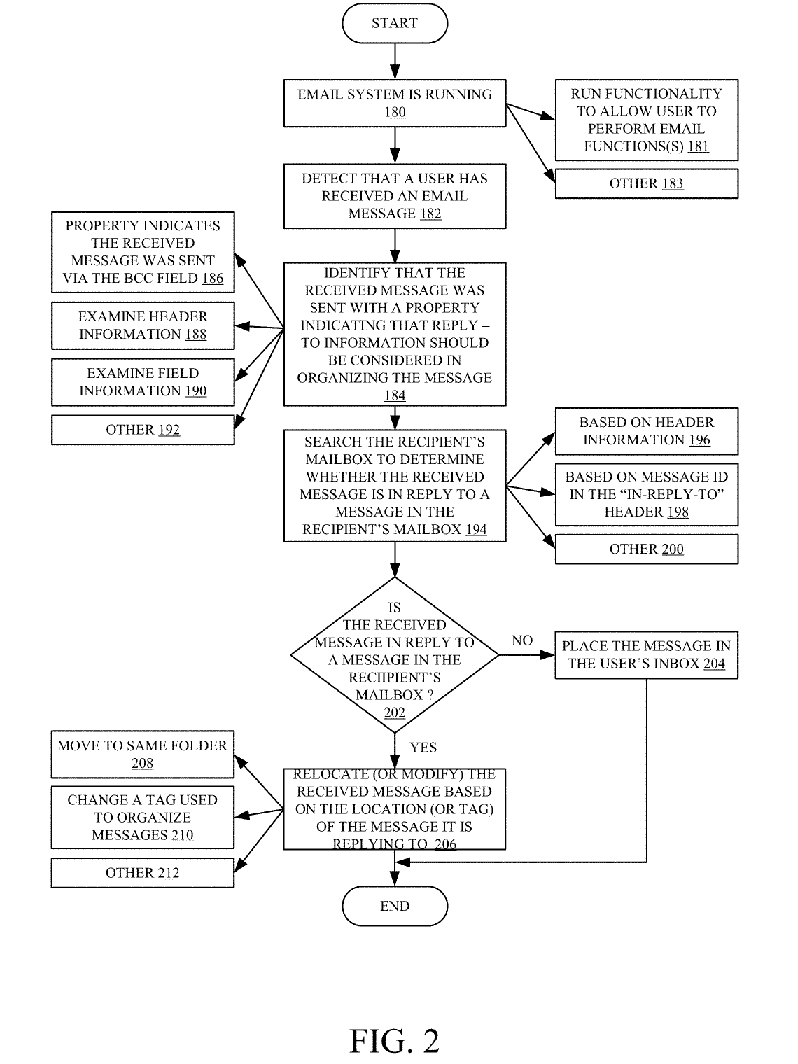

FIG. 2 is a flow diagram illustrating one example of the operation of the architecture shown in FIG. 1 in handling received messages that have a property or attribute indicating that, if they are in reply to another message in the user's inbox, this may be important in how the message is automatically organized. In the example discussed herein, that property or attribute will be whether the sender of the received message specified the recipient via the Bcc address box. It is first assumed that e-mail system 102 is running and the email functionality is running. This is indicated by block 180 in the flow diagram of FIG. 2. Bcc mail handling system 126 then detects that a user (e.g., user 118) has received an e-mail message. This is indicated by block 182.

Bcc identifier logic 142 then detects that the received message was sent with a property indicating that the reply-to information should be considered in organizing the message. This is indicated by block 184. In the example discussed herein, that property indicates that the received message was sent via the Bcc address box (or Bcc field). This is indicated by block 186. Bcc identifier logic 142 can do this by examining header information on the received message. This is indicated by block 188. It can also do this by identifying which address boxes have content in them that matches the user's e-mail address. Examining the field (or address box) information is indicated by block 190 in the flow diagram of FIG. 2. This can be done in a wide variety of other ways as well, and this is indicated by block 192.

Once it has been identified that the message was received via the Bcc address box, then mailbox search logic 144 searches the recipient's mailbox to determine whether the received message is in reply to another message that is already in the recipient's mailbox. This is indicated by block 194 in the flow diagram of FIG. 2. Again, this can be based on comparing header information in the received message to header information in the other messages in the recipient's mailbox. This is indicated by block 196. In one example, the message identifier in the “in-reply-to” header of the received message is compared with the message identifiers in the recipient's mailbox to determine whether the received message is in reply to another message in the user's mailbox. This is indicated by block 198. Determining whether the received message is in reply to a message in the recipient's mailbox may be done in a wide variety of other ways as well, and this is indicated by block 200. For example, text comparison on the message body can be used, so that if the received message contains a large chunk of text that is identical to an existing message (especially if it is marked as being a quote—such as in quote marks, or indented), the received message may be identified as replying to the existing message. This is only an example.

Determining whether the received message is in reply to a message in the recipient's mailbox, based upon the search results, is indicated by block 202. If not, then the message is not processed further by Bcc mail handling system 126, and it is placed in the user's inbox. This is indicated by block 204 in the flow diagram of FIG. 2.

However, if, at block 202, it is determined that the received message is in reply to a prior message in the recipient's mailbox, then message relocation (or modification) logic 146 relocates (or reorganizes or modifies) the received message based on the location of the prior message it is replying to. This is indicated by block 206. In one example, logic 146 moves the received message to the same folder as the prior message that it is replying to. This is indicated by block 208 in the flow diagram of FIG. 2. In an e-mail system where the messages may not be arranged in folders, but are instead tagged for organizational purposes, then message relocation (or modification) logic 146 reorganizes the message by changing the organizational tag so the received message is organized with the message that it is replying to. This is indicated by block 210 in the flow diagram of FIG. 2. It will be appreciated that the received message can be relocated (or modified or reorganized) in other ways as well, and this is indicated by block 212.

It can thus be seen that the recipient will now not see the received message in his or her inbox, even if it is received via Bcc, so long as it is in reply to another message (such as a prior group message). Instead, the message will be reorganized to go along with the prior group message that it is in reply to (such as placed in the same folder or tagged with the same organizational tag, etc.). Another feature should be noted, it will be noted that, in one example, if the prior message that the received message is in reply to is found in the recipient's sent items folder, then the received message may not be delivered to the sent items folder. This alleviates scenarios in which the received message would be undesirably organized into the sent items folder, when it was not actually an e-mail message that the recipient had previously sent. Also, if the recipient of the received message is also the sender (i.e., the sender placed his or her own email address in the “To” field) then the received message also may not be given the same folder or tag as the found message. This is by way of example only.

It can thus be seen that the present description provides a mechanism for automatically organizing messages that were not previously organizable using normal rules. This enhances the flexibility of the computing system itself and it also greatly enhances the user experience.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

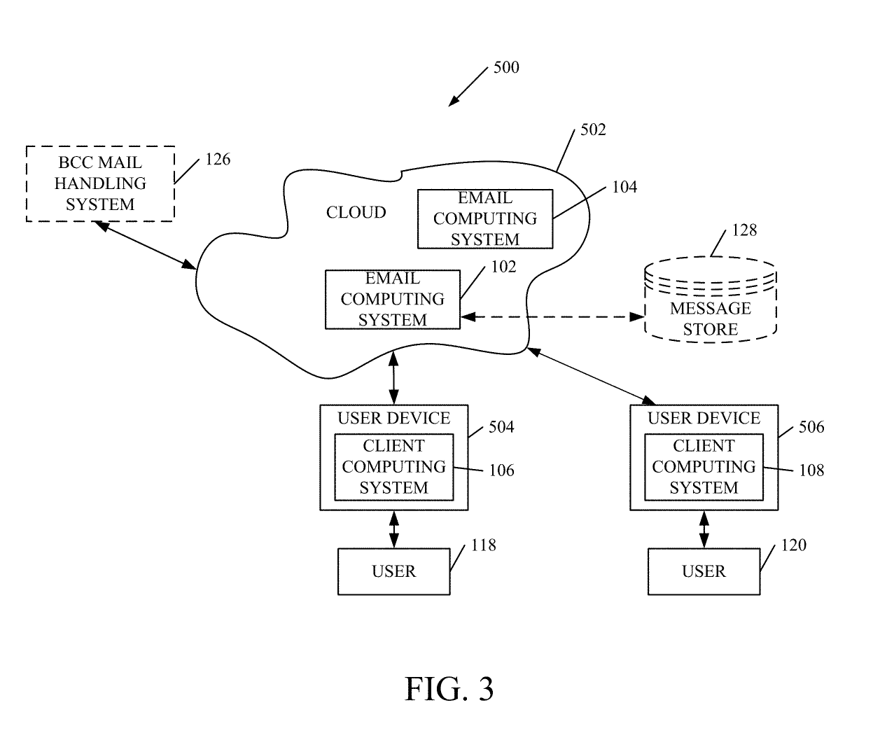

FIG. 3 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 3, some items are similar to those shown in FIG. 1 and they are similarly numbered. FIG. 3 specifically shows email systems 102 and 104 can be located in cloud 502 (which can be public, private, or a combination where portions are public while others are private). Therefore, users 118-120 use user devices 504-506 to access those systems through cloud 502.

FIG. 3 also depicts another example of a cloud architecture. FIG. 3 shows that it is also contemplated that some elements of architecture 100 can be disposed in cloud 502 while others are not. By way of example, data store 128 can be disposed outside of cloud 502, and accessed through cloud 502. In another example, Bcc handling system 128 or one or both email systems can be outside of cloud 502. Regardless of where they are located, they can be accessed directly by devices 504-506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

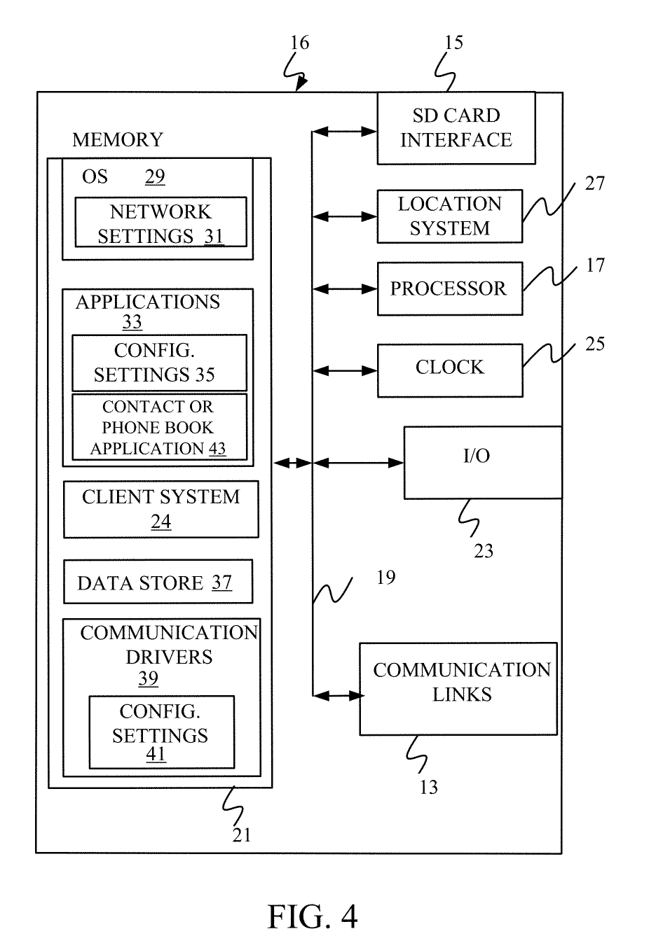

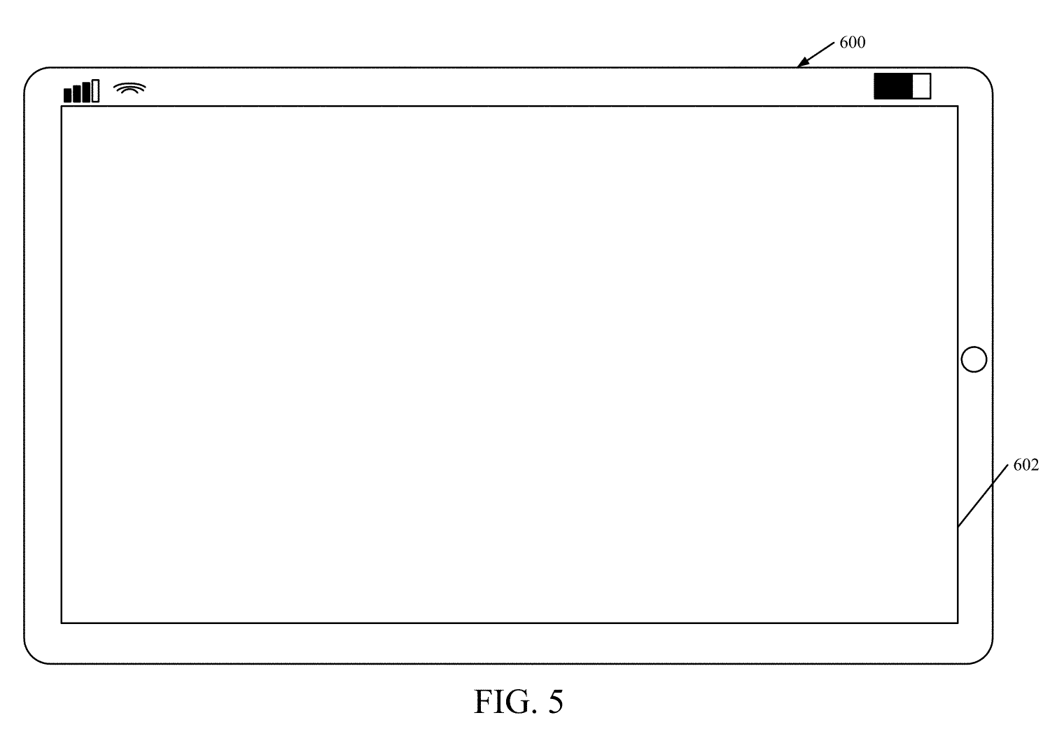

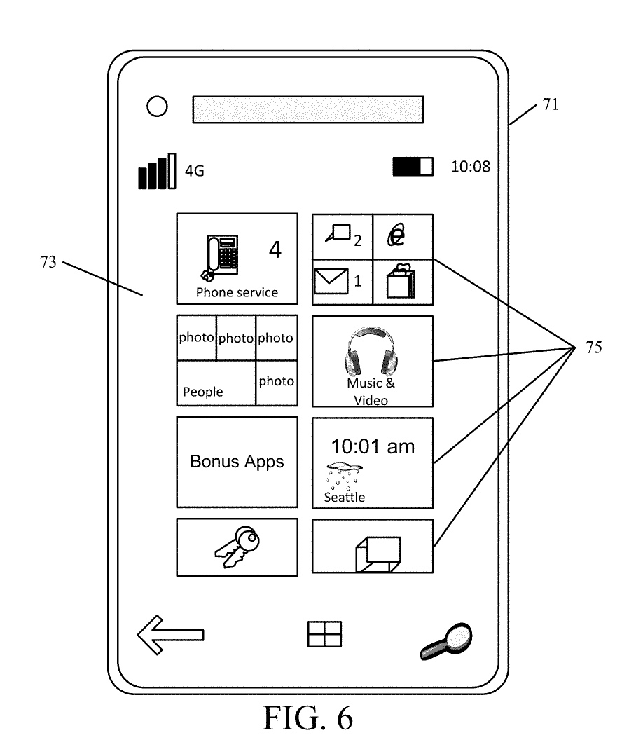

FIG. 4 is a simplified block diagram of one illustrative example of a handheld or mobile computing device that can be used as a user's or client's hand held device 16, in which the present system (or parts of it) can be deployed. FIGS. 5-6 are examples of handheld or mobile devices.

FIG. 4 provides a general block diagram of the components of a client device 16 that can run components of architecture 100 or that interacts with architecture 100, or both. In the device 16, a communications link 13 is provided that allows the handheld device to communicate with other computing devices and under some examples provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers 122 or 162 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 5 shows one example in which device 16 is a tablet computer 600. In FIG. 5, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 6 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

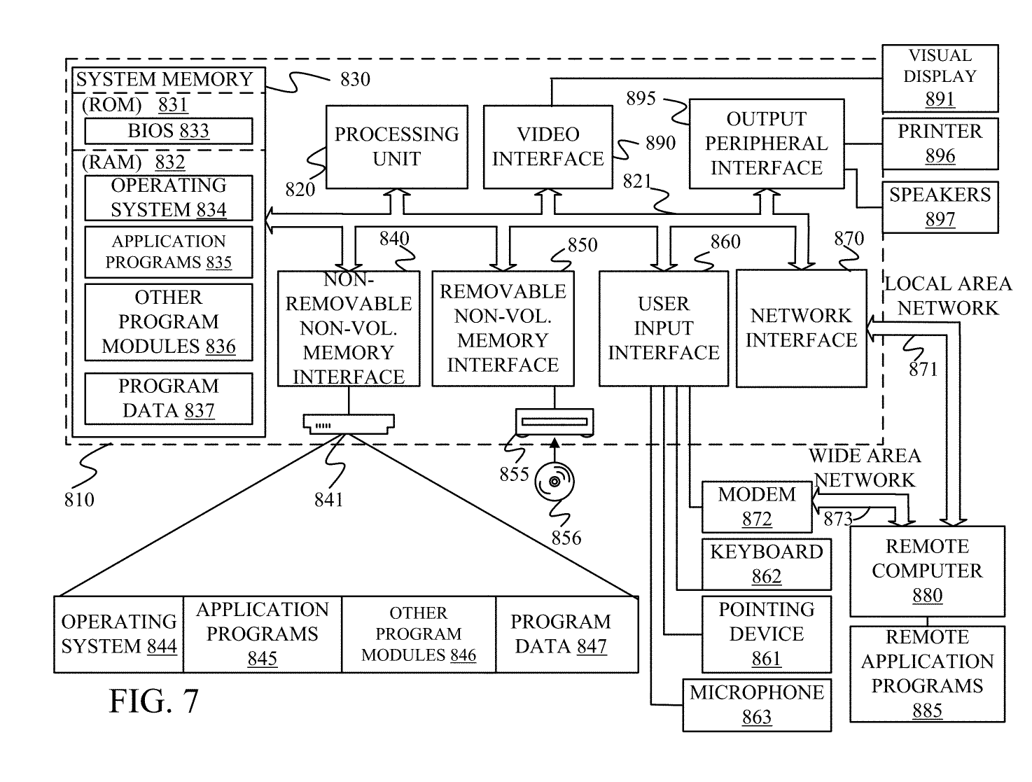

FIG. 7 is one example of a computing environment in which architecture 100, or parts of it, (for example) can be deployed. With reference to FIG. 7, an example system for implementing some embodiments includes a general-purpose computing device in the form of a computer 810. Components of computer 810 may include, but are not limited to, a processing unit 820 (which can comprise processors 122 and/or 162), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 7.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 7, provide storage of computer readable instructions, data structures, program modules and other data for the computer 810. In FIG. 7, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 7 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

electronic mail (email) functionality that performs email functions in response to user inputs;

property identifier logic that identifies a property, corresponding to a received message, indicative of the received message being received by a recipient due to an address placed by a sender in a blind carbon copy (BCC) address box and that generates a bcc message signal based on identification of the property corresponding to the received message; and

organization logic that, based on the bcc message signal, organizes the received message in a mailbox for the recipient based on reply-to information in the received message.

Example 2 is the computing system of any or all previous examples wherein the organization logic comprises:

mailbox search logic that identifies a reply-to message identifier in the received message, identifying a message that the received message is in reply to, and searches the recipients mailbox based on the reply-to message identifier to identify the message that the received message is in reply to.

Example 3 is the computing system of any or all previous examples wherein the mailbox search logic compares the reply-to message identifier to message identifiers on other messages in the recipient's mailbox to identify the message that the received message is in reply to.

Example 4 is the computing system of any or all previous examples wherein the recipient's mailbox has a plurality of different folders and wherein the organization logic comprises:

message relocation logic that places the received message in a same folder as the identified message that the received message is in reply to.

Example 5 is the computing system of any or all previous examples wherein the recipient's mailbox has messages organized based on a plurality of different organizational tags and wherein the organization logic comprises:

message modification logic that tags the received message with a tag corresponding to the identified message that the received message is in reply to.

Example 6 is the computing system of any or all previous examples wherein the property identifier logic accesses a header property on the received message to identify that it was received by the recipient due to the sender placing the address in the bcc address box.

Example 7 is a computer implemented method, comprising:

running electronic mail (email) functionality that performs email functions in response to user inputs;

identifying a property, corresponding to a received message, indicative of the received message being received by a recipient through an address in a blind carbon copy (bcc) address box;

generating a bcc message signal based on identification of the property corresponding to the received message; and

based on the bcc message signal, organizing the received message in a mailbox for the recipient based on reply-to information in the received message.

Example 8 is the computer implemented method of any or all previous examples wherein organizing the received message comprises:

identifying a reply-to message identifier in the received message, the reply-to message identifier identifying a message that the received message is in reply to.

Example 9 is the computer implemented method of any or all previous examples wherein organizing the message comprises:

searching the recipient's mailbox based on the reply-to message identifier to identify the message that the received message is in reply to.

Example 10 is the computer implemented method of any or all previous examples wherein searching comprises:

comparing the reply-to message identifier to message identifiers on other massages in the recipient's mailbox to identify the message that the received message is in reply to.

Example 11 is the computer implemented method of any or all previous examples wherein the recipient's mailbox has a plurality of different folders and wherein organizing comprises:

moving the received message to a same folder as the identified message that the received message is in reply to.

Example 12 is the computer implemented method of any or all previous examples wherein the recipient's mailbox has messages organized based on a plurality of different organizational tags and wherein organizing comprises:

tagging the received message with a tag corresponding to the identified message that the received message is in reply to.

Example 13 is the computer implemented method of any or all previous examples wherein identifying a property comprises:

accessing a header property on the received message to identify that it was received by the recipient due to the address that a sender placed in the bcc address box.

Example 14 is a computing system, comprising:

electronic mail (email) functionality that performs email functions in response to user inputs;

a sort rule system that applies configurable sort rules to received email messages to organize the received email messages according to the applied sort rules;

property identifier logic that identifies a property, corresponding to a given received message, indicative of the given received message being received by a recipient due to an address placed in a blind carbon copy (BCC) address box on the given received message and that generates a bcc message signal based on identification of the property corresponding to the given received message; and

organization logic that, based on the bcc message signal, organizes the given received message in a mailbox for the recipient based on reply-to information in the given received message.

Example 15 is the computing system of any or all previous examples wherein the organization logic comprises:

mailbox search logic that identifies a reply-to message identifier in the given received message, identifying a prior message that the received message is in reply to, and searches the recipient's mailbox based on the reply-to message identifier to identify the prior message that the given received message is in reply to.

Example 16 is the computing system of any or all previous examples wherein the mailbox search logic is configured to compare the reply-to message identifier to message identifiers on other massages in the recipient's mailbox to identify the prior message that the given received message is in reply to.

Example 17 is the computing system of any or all previous examples wherein the recipient's mailbox comprises a plurality of different folders.

Example 18 is the computing system of any or all previous examples wherein the organization logic comprises:

message relocation logic that places the given received message in a same folder as the prior message that the given received message is in reply to.

Example 19 is the computing system of any or all previous examples wherein the recipient's mailbox has messages organized based on a plurality of different organizational tags and wherein the organization logic comprises:

message relocation logic that tags the received message with a tag corresponding to the prior message that the given received message is in reply to.

Example 20 is the computing system of any or all previous examples wherein the property identifier logic accesses a header property on the given received message to identify that it was received by the recipient due to the address placed by a sender in the bcc address box.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
electronic mail (email) functionality that performs email functions in response to user inputs;
property identifier logic that identifies a property, corresponding to a received message, indicative of the received message being received by a recipient due to an address placed by a sender in a blind carbon copy (BCC) address box and that generates a bcc message signal based on identification of the property corresponding to the received message; and
organization logic that, based on the bcc message signal, organizes the received message in a mailbox for the recipient based on reply-to information in the received message.

2. The computing system of claim 1 wherein the organization logic comprises:
mailbox search logic that identifies a reply-to message identifier in the received message, identifying a message that the received message is in reply to, and searches the recipients mailbox based on the reply-to message identifier to identify the message that the received message is in reply to.

3. The computing system of claim 2 wherein the mailbox search logic compares the reply-to message identifier to message identifiers on other messages in the recipient's mailbox to identify the message that the received message is in reply to.

4. The computing system of claim 3 wherein the recipient's mailbox has a plurality of different folders and wherein the organization logic comprises:
message relocation logic that places the received message in a same folder as the identified message that the received message is in reply to.

5. The computing system of claim 3 wherein the recipient's mailbox has messages organized based on a plurality of different organizational tags and wherein the organization logic comprises:
message modification logic that tags the received message with a tag corresponding to the identified message that the received message is in reply to.

6. The computing system of claim 1 wherein the property identifier logic accesses a header property on the received message to identify that it was received by the recipient due to the sender placing the address in the bcc address box.

7. A computer implemented method, comprising:
running electronic mail (email) functionality that performs email functions in response to user inputs;
identifying a property, corresponding to a received message, indicative of the received message being received by a recipient through an address in a blind carbon copy (bcc) address box;
generating a bcc message signal based on identification of the property corresponding to the received message; and
based on the bcc message signal, organizing the received message in a mailbox for the recipient based on reply-to information in the received message.

8. The computer implemented method of claim 7 wherein organizing the received message comprises:
identifying a reply-to message identifier in the received message, the reply-to message identifier identifying a message that the received message is in reply to.

9. The computer implemented method of claim 8 wherein organizing the message comprises:
searching the recipient's mailbox based on the reply-to message identifier to identify the message that the received message is in reply to.

10. The computer implemented method of claim 9 wherein searching comprises:
comparing the reply-to message identifier to message identifiers on other massages in the recipient's mailbox to identify the message that the received message is in reply to.

11. The computer implemented method of claim 10 wherein the recipient's mailbox has a plurality of different folders and wherein organizing comprises:
moving the received message to a same folder as the identified message that the received message is in reply to.

12. The computer implemented method of claim 10 wherein the recipient's mailbox has messages organized based on a plurality of different organizational tags and wherein organizing comprises:
tagging the received message with a tag corresponding to the identified message that the received message is in reply to.

13. The computer implemented method of claim 7 wherein identifying a property comprises:
accessing a header property on the received message to identify that it was received by the recipient due to the address that a sender placed in the bcc address box.

14. A computing system, comprising:
electronic mail (email) functionality that performs email functions in response to user inputs;
a sort rule system that applies configurable sort rules to received email messages to organize the received email messages according to the applied sort rules;
property identifier logic that identifies a property, corresponding to a given received message, indicative of the given received message being received by a recipient due to an address placed in a blind carbon copy (BCC) address box on the given received message and that generates a bcc message signal based on identification of the property corresponding to the given received message; and
organization logic that, based on the bcc message signal, organizes the given received message in a mailbox for the recipient based on reply-to information in the given received message.

15. The computing system of claim 14 wherein the organization logic comprises:
mailbox search logic that identifies a reply-to message identifier in the given received message, identifying a prior message that the received message is in reply to, and searches the recipient's mailbox based on the reply-to message identifier to identify the prior message that the given received message is in reply to.

16. The computing system of claim 15 wherein the mailbox search logic is configured to compare the reply-to message identifier to message identifiers on other massages in the recipient's mailbox to identify the prior message that the given received message is in reply to.

17. The computing system of claim 16 wherein the recipient's mailbox comprises a plurality of different folders.

18. The computing system of claim 17 wherein the organization logic comprises:
message relocation logic that places the given received message in a same folder as the prior message that the given received message is in reply to.

19. The computing system of claim 16 wherein the recipient's mailbox has messages organized based on a plurality of different organizational tags and wherein the organization logic comprises:
message relocation logic that tags the received message with a tag corresponding to the prior message that the given received message is in reply to.

20. The computing system of claim 14 wherein the property identifier logic accesses a header property on the given received message to identify that it was received by the recipient due to the address placed by a sender in the bcc address box.
